(19) United States
(12) Patent Application Publication
(10) Pub. No.: US 2013/0298920 A1
(43) Pub. Date: Nov. 14, 2013

(54) SMOKELESS TOBACCO ANALOGUE AND METHOD OF USE

(71) Applicant: Steven G. Lance, Erie, CO (US)

(72) Inventor: Steven G. Lance, Erie, CO (US)

(21) Appl. No.: 13/466,302

(22) Filed: May 8, 2012

(51) Int. Cl. A24B 15/16; B02C 23/20; B02C 23/08

(52) U.S. Cl. 131/270; 241/9; 241/8

(57) ABSTRACT

A smokeless tobacco analogue material comprises comminuted sunflower seed hulls that are processed to be tasteless and to have a consistency and feel similar or complementary to a smokeless tobacco product. The analogue material can be mixed with a smokeless tobacco product to dilute and eventually eliminate the smokeless tobacco being used. Such mixing and progressive dilution of the smokeless tobacco proportion being used progressively dilutes the smokeless tobacco product taste and the nicotine concentration being consumed by a user. Other flavorings can also be added to the tasteless analogue material if desired.

### BACKGROUND

1. Technical Field of the Invention

This invention is related to tobacco analogues and method of use, for example, as an aid for overcoming a habit, addiction, or desire for use of smokeless tobacco.

2. State of the Prior Art

Smokeless tobacco products, which generally are available commercially in several forms, e.g., snuff and chewing tobacco, contain nicotine as part of the tobacco ingredient, and nicotine is generally accepted to be an addictive substance that causes pleasant feelings and ultimately makes it difficult for many users of smokeless tobacco to quit using the substance. Snuff, also sometimes called snus (a Swedish term), is a fine-grain tobacco that is often packaged in convenient, personal-sized, pouches, tins, or other containers, while chewing tobacco generally comprises long strands of loose leaves, plugs, or twists of tobacco. Smokeless tobacco is generally used by placing it in the mouth where saliva dissolves the nicotine and other chemicals in the tobacco and exposes them to the tissue lining the user's mouth, which absorbs the nicotine and other chemicals into the bloodstream. Once in the bloodstream, nicotine is carried to, and affects, many parts of the user's body, including heart and blood vessels, hormones, metabolism, and brain, and it creates both physical and mental dependence and addiction. Regardless of the form, all smokeless tobacco products have chemicals known to cause cancer, i.e., carcinogens, which can and often do cause cancer of the mouth, pancreas, and esophagus, and smokeless tobacco products used orally can and often do cause other health problems, such as gum disease, destruction of bone sockets around the teeth, and tooth loss, among other problems.

For these and other reasons, many users of smokeless tobacco products eventually want to quit using such products, but they find it difficult to quit because of the mental and/or physical addictiveness of nicotine as well as the mental habits that have been formed and associated with such use, e.g., having something in the mouth to suck or chew, etc. Such physical and mental dependencies often result in unpleasant withdrawal symptoms for a person who tries to quit using tobacco, which may include, for example, dizziness, depression, feelings of frustration and impatience or anger, anxiety, irritability, sleep problems, lack of ability to concentrate, restlessness and boredom, headaches, tiredness, increased appetite, and slower heart rate. Therefore, for at least a significant number of tobacco users, quitting is not an easy undertaking.

A variety of products and techniques have been proposed and developed to assist smokeless tobacco users in their quest to quit using smokeless tobacco. One such technique involves providing nicotine in a different form that does not include the other harmful chemicals in tobacco, sometimes known as nicotine replacement therapy. Such substitute nicotine products are available in several forms, such as nicotine gum, nicotine patches, nicotine lozenges, nicotine inhalers, and nicotine nasal sprays. Prescription anti-depressants such as bupropion reduce symptoms of nicotine withdrawal. Varencine is a prescription drug that interferes with nicotine receptors in the brain to reduce the physical pleasures associated with nicotine.

A variety of non-drug products are also available to aid a smokeless tobacco user in quitting the use of smokeless tobacco products. Examples include tea, clover, mint leaves, kudzu, and alfalfa, which are packaged similar to most snuff in a tin or pouch, and are available in different flavors. Such non-tobacco snuffs can be used alone or mixed with regular snuff as a person tries to cut down on tobacco use.

The foregoing examples of the related art and limitations related therewith are intended to be illustrative and not exclusive. Other limitations of the related art will become apparent to persons skilled in the art upon a reading of this material.

### DETAILED DESCRIPTION OF EXAMPLE EMBODIMENTS

An example smokeless tobacco analogue embodiment of this invention comprises organic material that is comminuted to a size gradation and prepared in a manner that generally feels similar to a smokeless tobacco product in a user's mouth. The smokeless tobacco analogue material (sometimes call “analogue material” or simply “analogue” for convenience herein) can also have a moisture content that feels similar to a smokeless tobacco product when placed in a user's mouth. The analogue can be used alone in a user's mouth or in a mixture with a smokeless tobacco product, as will be discussed in more detail below. In one example implementation, it is beneficial for the analogue to be tasteless or at least sufficiently tasteless to the user that it does not noticeably alter, annul, suppress, cover, or conceal the taste of a smokeless tobacco product with which it is mixed, even though it may weaken the taste intensity of the smokeless tobacco product, depending on the extent to which the smokeless tobacco product is diluted, i.e., cut, or adulterated, by the analogue in the mixture. It is also beneficial in this example embodiment and in other embodiments that the analogue has no nicotine. However, taste and/or nicotine could be added or included in the analogue if desired for some applications.

Sunflower seed hulls (sometimes called sunflower seed shells) is an example organic material that has been found to be particularly facilitative of attaining these and other attributes that are beneficial for a smokeless tobacco analogue. Sunflower seed hulls are the outer covering of sunflower seeds and are composed mostly of cellulose. Sunflower seed hulls are available commercially as residue after sunflower seeds are hulled to remove the more valuable and nutritious sunflower seed kernels for food or oil products, thus sunflower seed hulls are an inexpensive commodity and easily obtainable.

In one example embodiment, the sunflower seed hulls are processed to attain the desired size gradation, moisture content, and tasteless attributes. The hulls can be comminuted either dry or wet, and some additional processing, for example, boiling or heating to remove oils and other superfluous matter that may have a taste. In general, the resulting analogue material has the following characteristics:
Particle size gradation with at least 90 percent of the particles being sized somewhere in a range between 0.038 mm and 4.0 mm, and at least 70 percent of the particles being sized in a range between 0.053 mm and 2.0 mm, and at least 50 percent of the particles being sized in a range between 0.25 mm and 2.0 mm.
At least 85 percent by weight of the dry matter in the analogue material is organic matter. Dry matter as used in this criteria is the matter in the analogue material other than moisture, water, or other liquid. For example, if the analogue material was completely dried, i.e., all of the moisture, water, or other liquids were removed, the remaining material would be the “dry matter”. Therefore, for analytical purposes, a moist sample of the analogue material is considered to have “dry matter” content, even if the moisture, water, or other liquid may or may not have been removed.

While the analogue material can be packaged and/or used dry as a smokeless tobacco analogue, packaging and/or using it moist has the advantage of mimicking or feeling somewhat more like a one or more typical smokeless tobacco products, such as typical snuff and chewing tobacco products, and the analogue is mixable with one or more of such typical smokeless tobacco products without noticeably altering or affecting their moisture content or touch sensation on the user's fingers, lips, tongue, or mouth tissues. The analogue material with moisture (e.g., water) content in a range of 70 to 85 percent by weight generally provides these benefits.

One example process to attain these characteristics and attributes may include the following:

### EXAMPLE I

Half-fill a 1.5 liter blender container with raw hulls of unsalted, food grade (sometimes called confectionary) sunflower seed hulls. Add enough water to fill the blender container to its full 1.5 liter capacity. Blend the mixture of hulls and water in the container on a high speed blender setting to comminute the hulls and to mix the water and comminuted hulls for approximately 5 to 10 minutes or until the desired consistency is attained. Strain the mixture with a chef-type stainless steel food strainer while rinsing with water to remove fines and materials dissolved in the water. Boil the strained, comminuted hulls covered with water in a stainless steel pan for 3 to 10 minutes to separate oils and other superfluous materials, which rise to the top of the water, and skim or decant the oils and superfluous scum materials from the water. Strain the remaining boiled, comminuted hull material again with the chef-type food strainer while rinsing with water and allow to cool down to room temperature. The comminuted sunflower seed hull material resulting from this process can be used or packaged immediately as a smokeless tobacco analogue or it can be further dried to a desired moisture content for use and/or packaging.

The food strainer in the Example I is a standard food strainer with a 18-0 stainless steel mesh size U.S. #30 (0.0232 inch. or 595 microns opening), but any strainer or sieve with appropriate sized openings to accommodate a thorough rinsing of the comminuted hull material while retaining particle sizes appropriate for the texture desired for the resulting analogue material can be used. For example, a mesh or sieve in a size range of U.S. mesh # 10 to U.S. mesh # 100 e.g., opening sizes in a range of 2.0 to 0.149 mm, can provide satisfactory particle size gradations for the analogue material for use with some typical styles and brands of smokeless tobacco, but other sizes may be useful for additional embodiments or implementations of the analogue material.

Three samples of the analogue material prepared as described in Example I were tested for moisture content (water) by weighing each sample before and after drying. Sample #1 had 23.3 percent dry matter, thus 76.7 percent moisture content. Sample #2 had 20.6 percent dry matter, thus 79.4 percent moisture content. Sample #3 had 21.4 percent dry matter, thus 78.6 percent moisture content.

The dry matter for each sample was then tested for particle size gradation. The particle size distribution for each sample is shown in Table I.

TABLE I
Percent retained by the following sieve sizes

| Sample | 4.0 mm | 2.0 mm | 1.0 mm | 0.50 mm | 0.25 mm | 0.106 mm | 0.053 mm | 0.045 mm | 0.038 mm | 0.032 mm |
|---|---|---|---|---|---|---|---|---|---|---|
| #1 | 0 | 0 | 23.5 | 44.0 | 14.4 | 8.23 | 6.58 | 2.14 | 1.16 | 0 |
| #2 | 0 | 1.8 | 39.4 | 39.3 | 10.8 | 3.91 | 2.58 | 1.08 | 1.06 | 0 |
| #3 | 0 | 10.3 | 55.2 | 16.9 | 9.23 | 2.65 | 2.04 | 2.39 | 1.32 | 0 |

As mentioned above, sunflower seed hulls are composed mostly of cellulose, and they decompose slowly. With these characteristics, the comminuted sunflower seed hull material described above were observed to have a consistency and feel remarkably similar to smokeless tobacco products, e.g., snuff, and they were tasteless or substantially tasteless. Therefore, this comminuted sunflower seed hull material, with the oils and other superfluous material removed, is suitable and has beneficial characteristics for use as a tasteless tobacco analogue, for example, as described herein. For purposes of this description, tasteless means that the material has no discernible taste, and substantially tasteless is considered to mean that the material has insufficient taste to noticeably alter, annul, suppress, cover, or conceal the taste of a smokeless tobacco product with which it is mixed, even though mixing the analogue with the smokeless tobacco may weaken the taste intensity of the smokeless tobacco product by reducing the concentration of the smokeless tobacco product in the mixture, depending on the extent to which the smokeless tobacco is diluted, i.e., cut, or adulterated, by the analogue in the mixture.

Persons skilled in the art will recognize, after reading this description, that the sunflower seed hulls can be processed in a number of other ways or sequences to obtain these characteristics and benefits desired as an analogue for a smokeless tobacco product. For example, the sunflower seed hulls could be comminuted dry and then mixed with water and boiled. Also, one or more solvents could be used to extract and remove oils and other superfluous, tasteable materials from the sunflower seed hulls either before or after comminuting.

An example use of the smokeless tobacco analogue described above is use of the analogue as an aid to help overcome the mental and physical habits and nicotine addiction of a person who wants to quit using a smokeless tobacco product. An example implementation for such use is to gradually, but progressively, mix increasing proportions of the analogue material with a smokeless tobacco product that the person is using, i.e., to gradually, but progressively dilute or cut the smokeless tobacco product with more and more of the analogue material until the analogue material completely replaces the smokeless tobacco product. As the proportion of the analogue material is increased in relation to the smokeless tobacco product in the mixture, the taste as well as the nicotine concentration of the smokeless tobacco in the mixture decreases. When the analogue completely replaces the smokeless tobacco product so that the user is using only unadulterated analogue material with no smokeless tobacco product, then, of course, there is no more smokeless tobacco taste and no more nicotine in the user's mouth. Eventually, when the user is using the analogue material alone, i.e, no longer using a mixture with some content or concentration of smokeless tobacco, the user might choose to continue using the analogue material alone or with some other material, for example, to at least partially satisfy the habit, desire, or enjoyment of having the analogue material in the mouth. However, the user might decide to simply stop using the analogue, perhaps finding that use of the analogue is no longer enjoyed and no longer desired or needed in order to refrain from smokeless tobacco use.

One example implementation regimen may be as follows:

### EXAMPLE II

### Days 1, 2, and 3:

Step 1—Start with a full can or pouch of snuff. Remove and discard one-fourth of the snuff from the full can or pouch.

Step 2—Replace the one-fourth portion of the snuff that was removed from the can or pouch with the smokeless tobacco analog material so that the contents of the can or pouch is three-fourths proportion of snuff and one-fourth proportion of the analogue material.

Step 3—Mix the remaining three-fourths portion of the snuff with the replacement one-fourth portion of the analogue material thoroughly. It may be helpful to dump the snuff and analogue material into a bowl or other larger container in order to mix it thoroughly with a mixing utensil and then put the mixture back into the snuff can or pouch.

Step 4—Use the mixture comprising the three-fourths proportion of snuff and one-fourth proportion of analogue material in the same way the snuff had been used previously, e.g., by placing it in the user's mouth between the gum and the cheek, and continue using the mixture in that manner through days 1, 2, and 3.

### Days 4, 5, 6, and 7:

Step 1—Start with a full can or pouch of snuff Remove and discard one-half of the snuff from the full can or pouch.

Step 2—Replace the one-half portion of the snuff that was removed from the can or pouch with the smokeless tobacco analogue material so that the contents of the can or pouch is one-half proportion of snuff and one-half proportion of the analogue material.

Step 3—Mix the remaining one-half portion of the snuff with the replacement one-half portion of the analogue material thoroughly. It may be helpful to dump the snuff and analogue material into a bowl or other larger container in order to mix it thoroughly with a mixing utensil and then put the mixture back into the snuff can or pouch.

Step 4—Use the mixture comprising the half-half proportion of snuff and one-half proportion of analogue material in the same way the snuff had been used previously, e.g., by placing it in the user's mouth between the gum and the cheek, and continue using the mixture in that manner through days 4, 5, 6, and 7.

### Days 8, 9, and 10:

Step 1—Start with a full can or pouch of snuff. Remove and discard three-fourths of the snuff from the full can or pouch.

Step 2—Replace the three-fourths portion of the snuff that was removed from the can or pouch with the smokeless tobacco analogue material so that the contents of the can or pouch is one-fourth proportion of snuff and three-fourths proportion of the analogue material.

Step 3—Mix the remaining one-fourth portion of the snuff with the replacement three-fourths portion of the analogue material thoroughly. It may be helpful to dump the snuff and analogue material into a bowl or other larger container in order to mix it thoroughly with a mixing utensil and then put the mixture back into the snuff can or pouch.

Step 4—Use the mixture comprising the one-fourth proportion of snuff and three-fourths proportion of analogue material in the same way the snuff had been used previously, e.g., placing it in the user's mouth between the gum and the cheek, and continue using the mixture in that manner through days 8, 9, and 10.

Day 11 and beyond:

Step 1—Fill a can or pouch with, or use a can or pouch filled with, 100 percent of the analogue material.

Step 2—Use the analogue material in the same way the snuff had been used previously for as many days as desired or tolerated.

The analogue material in this example has no nicotine content, so the user's intake of nicotine decreases as the smokeless tobacco proportion of the mixture used by the user is decreased. Therefore, gradually decreasing the smokeless tobacco proportion of mixtures being used by the user gradually weans the user from nicotine intake. It has been observed that one or several days of using the substantially tasteless analogue material by itself with no smokeless tobacco content after the gradual or sequential weaning process can lead to the user tiring of the analogue material and/or growing bored with it enough to result in the frequency of use of the analogue material by the user decreasing rapidly and finally ending with the user no longer enjoying the analogue material and also having a diminished, if not eliminated, craving or need for the real smokeless tobacco product or nicotine.

The example smokeless analogue material described above is tasteless or substantially tasteless with no additional materials or flavorings. Also, the example use of the analogue material described above is in its tasteless or substantially tasteless embodiment with no additional materials or flavorings, except for the smokeless tobacco product with which it may be mixed for use as described. However, in another example embodiment, the analogue material could be flavored with any desired taste by adding a flavoring substance to the tasteless or substantially tasteless analogue material. Such a flavored embodiment of the analogue material could be used in a mixture with a smokeless tobacco product to mask, alter, conceal, or suppress the taste of the smokeless tobacco product, or a user could use the analogue material with a flavor after the user no longer uses any of the smokeless tobacco product. Any variation or blending of such procedures or uses with or without added flavoring could also be used. If the taste of the analogue material embodiment with the flavoring added is pleasant to the user, it may help the user to prolong the use of the analogue material to the exclusion of the smokeless tobacco product for a longer time, for example, if a longer time is needed by a particular user to further diminish the user's desire or need for nicotine.

While a number of example aspects, implementations, and embodiments have been discussed above, persons skilled in the art will recognize certain modifications, permutations, additions, variations, and subcombinations thereof, in addition to those examples mentioned above. It is therefore intended that the following appended claims hereafter introduced are interpreted to include all such modifications, permutations, additions, and subcombinations as are within their true spirit and scope. The words “comprise,” “comprises,” “comprising,” “comprised,” “compose,” “composing,” “composed,” “have,” “having,” “include,” “including,” and “includes” when used in this specification and in the following claims are intended to specify the presence of stated features, components, steps, or parts thereof, but they do not preclude the presence or addition of one or more other components, features, steps, or parts thereof.

The embodiments of the invention in which an exclusive property or privilege is claimed are defined as follows:

1. A smokeless tobacco analogue material comprising comminuted sunflower seed hulls.

2. The smokeless tobacco analogue material of claim 1, wherein the smokeless tobacco analogue material is substantially tasteless.

3. The smokeless tobacco analogue material of claim 1, wherein the comminuted sunflower seed hulls are particles, and wherein at least 90 percent of the particles are sized in a range between 0.038 mm and 4.0 mm.

4. The smokeless tobacco analogue material of claim 1, wherein the comminuted sunflower seed hulls are particles, and wherein at least 70 percent of the particles are sized in a range between 0.053 mm and 2.0 mm.

5. The smokeless tobacco analogue material of claim 1, wherein the comminuted sunflower seed hulls are particles, and wherein at least 50 percent of the particles are sized in a range between 0.025 mm and 2.0 mm.

6. The smokeless tobacco analogue material of claim 1, wherein the comminuted sunflower seed hulls are particles, and wherein at least 90 percent of the particles are sized in a range between 0.038 mm and 4.0 mm, at least 70 percent of the particles are sized in a range between 0.053 mm and 2.0 mm, and at least 50 percent of the particles are sized in a range between 0.025 mm and 2.0 mm.

7. The smokeless tobacco analogue material of claim 1, wherein the smokeless tobacco analogue material has moisture content in a range of 70 to 85 percent by weight.

8. The smokeless tobacco analogue material of claim 1, wherein at least 85 percent of the smokeless tobacco analogue dry matter content by weight is organic.

9. A smokeless tobacco analogue material consisting of comminuted sunflower seed hulls that have been processed to be tasteless or substantially tasteless and to have particle size gradation in which at least 90 percent of the particles are sized in a range between 0.038 mm and 4.0 mm, at least 70 percent of the particles are sized in a range between 0.053 mm and 2.0 mm, and at least 50 percent of the particles are sized in a range between 0.025 mm and 2.0 mm.

10. A method of providing a smokeless tobacco analogue material, comprising:
comminuting sunflower seed hulls; and
removing oils and debris from the comminuted sunflower seed hulls that have taste to leave remaining comminuted sunflower hull material that is tasteless or substantially tasteless.

11. The method of claim 10, including removing the oils and debris by boiling the comminuted sunflower seed hulls in water and then decanting the oils and debris from the water.

12. The method of claim 11, including comminuting and straining the sunflower seed hulls to produce the tasteless or substantially tasteless comminuted sunflower material to have a particle size gradation in which at least 90 percent of the particles are sized in a range between 0.038 mm and 4.0 mm.

13. The method of claim 11, including comminuting and straining the sunflower seed hulls to produce the tasteless or substantially tasteless comminuted sunflower material to have a particle size gradation in which at least 70 percent of the particles are sized in a range between 0.053 mm and 2.0 mm.

14. The method of claim 11, including comminuting and straining the sunflower seed hulls to produce the tasteless or substantially tasteless comminuted sunflower material to have a particle size gradation in which at least 50 percent of the particles are sized in a range between 0.025 mm and 2.0 mm.

15. The method of claim 11, including comminuting and straining the sunflower seed hulls to produce the tasteless or substantially tasteless comminuted sunflower material to have a particle size gradation in which at least 90 percent of the particles are sized in a range between 0.038 mm and 4.0 mm, at least 70 percent of the particles are sized in a range between 0.053 mm and 2.0 mm, and at least 50 percent of the particles are sized in a range between 0.025 mm and 2.0 mm.

16. The method of claim 10, including adding a flavoring material to the tasteless or substantially tasteless comminuted sunflower hull material.

17. A method for a habitual user of a smokeless tobacco product to diminish the user's diminishing desire for using the smokeless tobacco product in a user's mouth, comprising:
preparing a mixture comprising the smokeless tobacco product and a smokeless tobacco analogue material, wherein the smokeless tobacco analogue material comprises comminuted sunflower seed hulls; and
using the mixture in the user's mouth in place of the smokeless tobacco product.

18. The method of claim 17, including:
preparing a plurality of additional mixtures comprising the smokeless tobacco product and the smokeless tobacco analogue material with individual ones of the additional mixtures having different proportions of the smokeless tobacco material in relation to the smokeless tobacco analogue material; and
sequentially using the additional mixtures in a sequence of decreasing proportions of the smokeless tobacco product and increasing proportions of the smokeless tobacco product analogue.

19. The method of claim 18, including following the sequence of using the additional mixtures with using only the smokeless tobacco analogue material in the user's mouth without any of the smokeless tobacco product.

20. The method of claim 17, wherein the smokeless tobacco analogue material is tasteless or substantially tasteless.
